(19) United States
(12) Patent Application Publication
(10) Pub. No.: US 2019/0295493 A1
(43) Pub. Date: Sep. 26, 2019

(54) METHOD, TERMINAL AND STORAGE MEDIUM FOR PREVENTING DISPLAY FROM IMAGE-STICKING

(71) Applicant: Beijing Xiaomi Mobile Software Co., Ltd., Beijing (CN)

(72) Inventors: Guilin Zhong, Beijing (CN); Guosheng Li, Beijing (CN); Zhengliang Liu, Beijing (CN)

(73) Assignee: Beijing Xiaomi Mobile Software Co., Ltd., Beijing (CN)

(21) Appl. No.: 16/221,091

(22) Filed: Dec. 14, 2018

(30) Foreign Application Priority Data
Mar. 21, 2018 (CN) 201810234726.X

(51) Int. Cl. G09G 5/00; G06F 9/30; G09G 3/3208; G06F 3/0481

(52) U.S. Cl. CPC G09G 5/003; G06F 9/30; G09G 2300/0861; G06F 3/04817; G09G 3/3208

(57) ABSTRACT

The disclosure relates to a method, a terminal and a non-transitory computer-readable storage medium for preventing a display from image-sticking. The method includes acquiring a target image frame to be displayed; determining image information of each display unit in the target image frame; determining, based on the image information of each display unit in the target image frame, at least one target display unit having respective image information that has not changed for a duration that is equal to or greater than a preset duration threshold; and changing an image of the at least one target display unit in a consecutive preset number of image frames.

This application is based on and claims priority to the Chinese Patent Application 201810234726.X, filed on Mar. 21, 2018, the entire contents of which are incorporated herein by reference.

### TECHNICAL FIELD

The present disclosure relates to a method, a terminal and a storage medium for preventing a display from image-sticking.

### BACKGROUND

Terminals may use organic light-emitting diodes (OLEDs) for image display.

After a terminal displays a certain static image for a long time, if the display is turned off, a residual image of the image will be left at the position of the image displayed in the display. This effect is called image-sticking, image burn-in, or ghost image. For example, if the user turns off the TV after watching the CCTV-1 channel on the TV for a long time, a residual image of “CCTV-1” will be left at the position where the symbol “CCTV-1” is displayed in a display of the TV. For another example, after a mobile phone displays a battery icon for a long time, the mobile phone has a black screen, and a residual image of the illuminated icon will be left at the position where the battery icon is displayed in a display of the mobile phone.

Since the service life of an OLED material emitting red, green and blue lights is limited in the OLED display, once the effect of image-sticking frequently occurs in the OLED display, the OLED material is likely to be prematurely aged.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the disclosure provide a method for preventing a display from image-sticking. The method includes acquiring a target image frame to be displayed; determining image information of each display unit in the target image frame; determining, based on the image information of each display unit in the target image frame, at least one target display unit having respective image information that has not changed for a duration that is equal to or greater than a preset duration threshold; and changing an image of the at least one target display unit in a consecutive preset number of image frames.

In an example, the consecutive preset number of image frames are subsequent to the target image frame.

According to an aspect, the display unit is a pixel point, and when determining the image information of each display unit in the target image frame, the method further includes determining a channel value of each color channel of each pixel point in the target image frame.

According to another aspect, the display unit is a display area composed of a plurality of pixel points, and when determining the image information of each display unit in the target image frame, the method further includes calculating a feature code corresponding to each display area respectively as image information corresponding to each display area based on a channel value of each color channel of the pixel points in each display area.

In an example, the image of the at least one target display unit in the consecutive preset number of image frames is changed into a preset image.

According to an aspect, when changing the image of the at least one target display unit in the consecutive preset number of image frames, the method further includes determining an interface content element corresponding to the at least one target display unit, and adjusting a position of the interface content element in the consecutive preset number of image frames subsequent to the target image frame.

In an example, the image information of the at least one target display unit does not correspond to pure black display content.

Aspects of the disclosure also provide a terminal for preventing a display from image-sticking. The terminal includes a processor and a memory for storing instructions executable by the processor. The processor is configured to acquire a target image frame to be displayed; determine image information of each display unit in the target image frame; determine, based on the image information of each display unit in the target image frame, at least one target display unit having respective image information that has not changed for a duration that is equal to or greater than a preset duration threshold; and change an image of the at least one target display units in a consecutive preset number of image frames.

Aspects of the disclosure also provide a non-transitory computer-readable storage medium storing instructions that, when executed by one or more processors of a device, cause the device to acquire a target image frame to be displayed; determine image information of each display unit in the target image frame; determine, based on the image information of each display unit in the target image frame, at least one target display unit having respective image information that has not changed for a duration that is equal to or greater than a preset duration threshold; and change an image of the at least one target display unit in a consecutive preset number of image frames.

It is to be understood that both the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate aspects consistent with the disclosure and, together with the description, serve to explain the principles of the disclosure.

FIG. 1 is a flow chart of a method for preventing a display from age-sticking according to an exemplary aspect of the present disclosure;

FIG. 2. A is a flow chart of a method for preventing a display from age-sticking according to another exemplary aspect of the present disclosure;

FIG. 2B is a schematic diagram of a mobile phone interface according to an exemplary aspect of the present disclosure;

FIG. 3 is a block diagram of a device for preventing a display from age-sticking according to an exemplary aspect of the present disclosure; and

FIG. 4 is a block diagram of a terminal according to an exemplary aspect of the present disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Reference will now be made in detail to exemplary aspects, examples of which are illustrated in the accompanying drawings. The following description refers to the accompanying drawings in which the same numbers in different drawings represent the same or similar elements unless otherwise represented. The implementations set forth in the following description of illustrative aspects do not represent all implementations consistent with the disclosure. Instead, they are merely examples of apparatuses and methods consistent with aspects related to the disclosure as recited in the appended claims.

The word “first”, “second” and other similar words mentioned herein are not intended to indicate any order, quantity, or importance, and are merely used to distinguish different components. Similarly, the word “a”, “an” or the like does not denote a quantity limitation, but means that there is at least one. The word “connected”, “connection” or the like is not limited to physical or mechanical connection, but may include electrical connection, either direct or indirect.

The “module” mentioned herein generally refers to programs or instructions stored in a memory and capable of performing certain functions. The “unit” mentioned herein generally refers to a functional structure logically divided. The word “unit” may be implemented by pure hardware or a combination of hardware and software.

The term “plurality” herein refers to two or more. “And/or” herein describes the association relationship of the associated objects, indicating three kinds of relationship. For example, A and/or B, can be expressed as: A exists alone, A and B exist concurrently, and B exists alone. The character “/” generally indicates that the context objects are in an “OR” relationship.

The aspects of the present disclosure will be described in further detail with reference to the enclosed drawings, to clearly present the principle and advantages of the present disclosure.

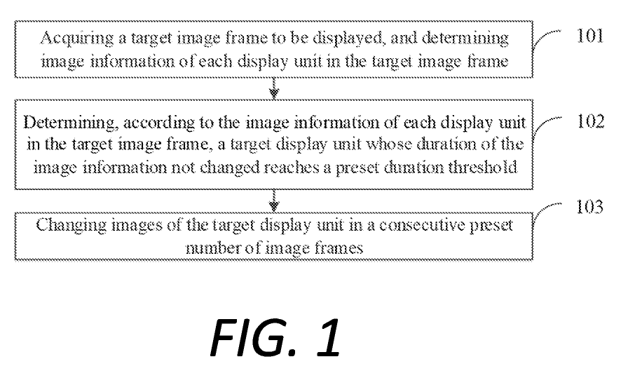

FIG. 1 is a flow chart of a method for preventing a display from image-sticking according to an exemplary aspects. As shown in FIG. 1, the method for preventing a display from image-sticking includes following steps.

In step 101, a target image frame to be displayed is acquired, and image information of each display unit in the target image frame is determined.

In step 102, according to the image information of each display unit in the target image frame, a target display unit whose duration of the image information not changed reaches a preset duration threshold is determined.

In step 103, images of the target display units in a consecutive preset number of image frames are changed.

In summary, according to the method for preventing a display from image-sticking provided by the aspects of the present disclosure, the target display unit whose duration of image information not changed reaches a preset duration threshold is determined according to the image information of each display unit in the target image frame in the image frames to be displayed. The images of the target display units in a consecutive preset number of image frames are changed. Since the duration of the image information of each display unit not changed does not reach the preset duration threshold, the problem of premature aging of the OLED material and the effect of the image-sticking since the OLED display displays the same image for a long time can be solved. The effects of preventing OLED display screen from image-sticking and prolonging the service life of the OLED material can be achieved.

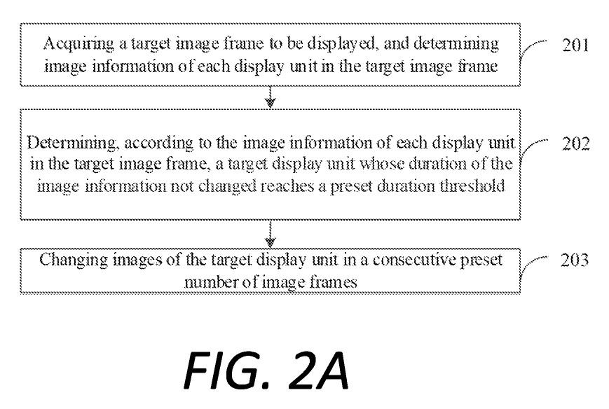

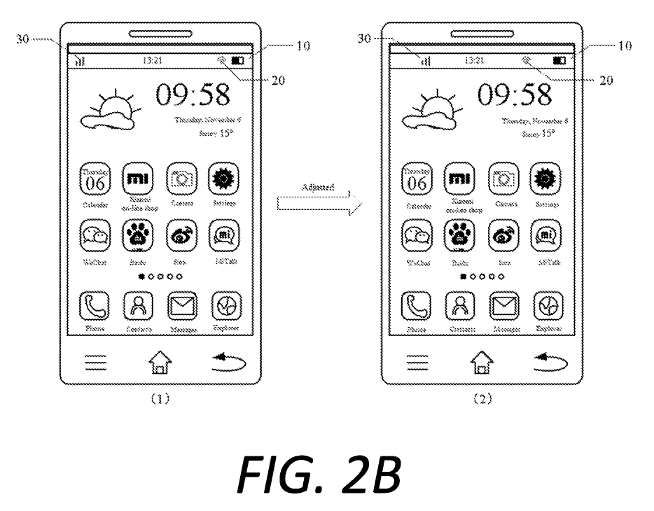

FIG. 2A is a flow chart of a method for preventing a display from image-sticking according to another exemplary aspect. As shown in FIG. 2A, the method for preventing a display from image-sticking comprises the following steps.

In step 201, a target image frame to be displayed is acquired, and image information of each display unit in the target image frame is determined.

Optionally, the present disclosure may be applied to the display driver integrated circuit (DDIC) of a display screen. Generally, the DDIC acquires and stores the image frame transmitted by a central processing unit (CPU) through a mobile industry processor interface (MIPI) bus, and converts the image frame into a specific electric signal to drive the screen for displaying.

When the display unit is a pixel point, the step of determining the image information of each display unit in the target image frame may be replaced by: determining a channel value of each color channel of each pixel point in the target image frame.

Exemplarily, before converting the image frame into the specific electric signal, the DDIC determines the channel value of each color (RGB) channel of each pixel point in the target image frame, and compares the channel values of the same pixel point in the former and latter frame images, thereby determining whether the channel values of each pixel point in the former and latter frame images are different.

When the display unit is a display area consisted of a plurality of pixel points, the step of determining the image information of each display unit in the target image frame may be replaced by: according to a channel value of each color channel of pixel points in each display area, respectively calculating a feature code corresponding to each display area as the image information corresponding to each display area.

Exemplarily, before converting the image frame into the specific electric signal, the DDIC respectively calculates the feature code corresponding to each display area as the image information corresponding to each display area according to the channel value of each color channel of the pixel point in each display area. The feature codes of the same display area in the former and latter frame images are compared, so as to determine whether the feature codes of each display area in the former and latter frame images are different.

Optionally, the feature code of the display area is calculated by accumulating the channel values of color channels of all the pixel points in the display area.

In step 202, according to the image information of each display unit in the target image frame, the target display unit whose duration of image information not changed reaches a preset duration threshold and the image information is not a preset image information is determined.

Herein, the preset image information is the image information corresponding to pure black display content.

Since the target display unit does not perform image display by default for the image information of the pure black display content, the target display unit that does not perform image display naturally does not have the risk of image-sticking. Therefore, it is necessary to determine that the image information is not the preset image information while it is determined that the duration of the image information not changed reaches the preset duration threshold.

When the display unit is a pixel point, if the channel values of the same pixel point in the former and latter frame images are the same, it is determined that the channel value of the pixel point is not changed.

When the display unit is a display area composed of a plurality of pixels, if the feature codes of the same display area in the former and latter frame images are the same, then the feature code of the display area is not changed.

It should be noted that the preset duration threshold may be manually preset, or may be preset by a system. The preset duration threshold may be 30 minutes, one hour, two hours, etc., and the specific value of the preset duration is not limited in the present aspect.

In step 203, images of the target display units in a consecutive preset number of image frames are changed.

The duration of image information of the target display unit not changed reaches a preset duration threshold, indicating that the target display unit always displays the same image information within the preset duration threshold. If the duration of displaying the same image information by the target display unit reaches the preset duration threshold, the target display unit has the risk of image-sticking. Therefore, when the duration of image information of the target display unit which is not changed reaches the preset duration threshold, the images of the target display units in the consecutive preset number of image frames are changed, and the image displayed by the target display unit after the change is different from the image whose display duration reaches the preset duration threshold.

Compared with the case where the display unit is the pixel point, when the display unit is a display area composed of a plurality of pixel points, the frequency that the DDIC changes the image of the target display unit is lower, and the pressure of processing the DDIC is reduced.

In a possible implementation, the step 203 may be replaced by: changing the image in the target display unit in a consecutive preset number of image frames into a preset image. Optionally, the preset image is a pure black image.

In another possible implementation, the step 203 can be replaced by changing the images of the target display units in a consecutive preset number of image frames including the target image frame and the image frames subsequent to the target image frame.

Since the target image frame is the to-be-displayed image frame cached in the terminal, after determining the target display unit whose duration of the image information not changed reaches the preset duration threshold, the terminal may directly change the image of the target display unit in a consecutive preset number of image frames including the target image frame and the image frames subsequent to the target image frame.

In yet another possible implementation, the step 203 can be replaced by: changing the images of the target display units in a consecutive preset number of image frames subsequent to the target image frame.

Optionally, the interface content element corresponding to the target display unit is determined, and the position of the interface content element is adjusted in a consecutive preset number of image frames subsequent to the target image frame.

Herein, when the terminal is a mobile device, the interface content element is an icon in a taskbar displayed by the mobile device (such as a Bluetooth icon, a headset icon, a Wireless-Fidelity (Wi-Fi) icon, etc., which is in a fixed position of the taskbar for long time).

FIG. 2B is a schematic diagram of a mobile phone interface according to an exemplary aspect. As shown in FIG. 2B (1), in the task bar 10 displayed in the mobile phone interface, taking the interface content element being Wi-Fi icon 20 and the signal icon 30 as an example, if the preset duration threshold is five hours, the display unit displaying the Wi-Fi icon 20 is the display unit A, and the display unit displaying the display signal icon 30 is the display unit B. When the DDIC in the mobile phone determines the display unit A and the display unit B whose durations of the image information are not changed for five hours, a prompt signal carrying a Wi-Fi icon identifier and a signal icon identifier is sent to the CPU, so as to trigger the CPU to adjust the positions of the Wi-Fi icon and the signal icon. The adjusted Wi-Fi icon and signal icon are combined with other image data to obtain the image frame that needs to be finally sent to the DDIC. After acquiring the image frame sent by the CPU, and converting the image frame into a specific electric signal, the DDIC drives the screen for display (as shown in FIG. 2B (2)).

It should be noted that the position adjustment of the interface content element is not limited to the adjustment of horizontal coordinates and the adjustment of longitudinal coordinates. The adjustment of the Wi-Fi icon 20 and the signal icon 30 in terms of the horizontal coordinates as shown in FIG. 2B (2) is only a possible adjustment manner.

It should be noted that in the aspects, the CPU only adjusts the position of the interface content element after receiving the prompt signal sent by the DDIC, and always combines the adjusted Wi-Fi icon and signal icon with other image data to obtain the image frame, before the prompt signal sent by the DDIC is received next time.

In summary, according to the method for preventing a display from image-sticking provided by the aspect of the present disclosure, the target display unit whose duration of image information not changed reaches the preset duration threshold is determined according to the image information of each display unit in the target image frame in the image frames to be displayed. The images of the target display units in a consecutive preset number of image frames are changed. Since the duration of the image information of each display unit is not changed does not reach the preset duration threshold, the problem of premature aging of the OLED material and the effect of the image-sticking due to the OLED display displays the same image for a long time can be solved. The effects of preventing OLED display screen from image-sticking and prolonging the service life of the OLED material can be achieved.

In the aspects, compared with the case where the display unit is the pixel point, when the display unit is the display area composed of a plurality of pixel points, the frequency that the DDIC changes the image of the target display unit is lower, and the pressure of processing the DDIC is lowered.

It should be noted that all the status names and the message names mentioned in the foregoing aspects are exemplary, which are not limited in the aspects. The same state features or the same message functions are considered to be in the protection scope of the present disclosure.

The following is a device aspect of the present disclosure, which can be used to implement the method aspect of the present disclosure. For the details not disclosed in the device aspects of the present disclosure, reference can be made to the method aspect of the present disclosure.

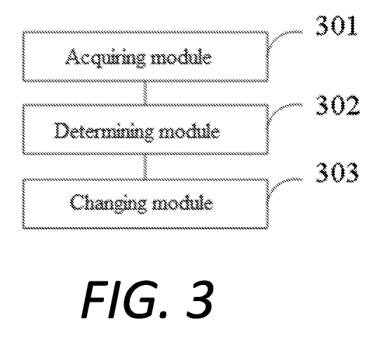

FIG. 3 is a block diagram of a device for preventing a display from image-sticking according to an exemplary aspect. As shown in FIG. 3, the device for preventing a display from image-sticking includes, but is not limited to: an acquiring module 301, a determining module 302 and a changing module 303.

The acquiring module 301 is configured to acquire a target image frame to be displayed, and determine image information of each display unit in the target image frame.

The determining module 302 is configured to determine, according to the image information of each display unit in the target image frame, the target display unit whose duration of the image information not changed reaches a preset duration threshold.

The changing module 303 is configured to change images of the target display units in a consecutive preset number of image frames.

Optionally, the changing module 303 is further configured to change the images of the target display units in a consecutive preset number of image frames subsequent to the target image frame.

Optionally, the display unit is a pixel point, and the acquiring module 301 includes a first determining unit configured to determine a channel value of each color channel of each pixel point in the target image frame.

Optionally, the display unit is a display area composed of a plurality of pixel points, and the acquiring module 301 includes: a second determining unit configured to, according to the channel value of each color channel of the pixel points in each display area, respectively calculate a feature code corresponding to each display area as the image information corresponding to each display area.

Optionally, the changing module 303 includes: a changing unit configured to change the images in the target display units in a consecutive preset number of image frames to be a preset image; a third determining unit configured to determine an interface content element corresponding to the target display unit, and adjust the position of the interface content element in a consecutive preset number of image frames subsequent to the target image frame.

Optionally, the determining module 302 is further configured to determine, according to the image information of each display unit in the target image frame, the target display unit whose duration of image information not changed reaches the preset duration threshold and the image information is not preset image information, wherein the preset image information is the image information corresponding to pure black display content.

In summary, according to the device for preventing a display from image-sticking provided by the aspects of the present disclosure, the target display unit whose duration of image information not changed reaches the preset duration threshold is determined according to the image information of each display unit in the target image frame in the image frames to be displayed. The images of the target display unit in a consecutive preset number of image frames are changed. Since the duration of the image information of each display unit which is not changed does not reach the preset duration threshold, the problem of premature aging of the OLED material and the effect of the image-sticking since the OLED display displays the same image for a long time can be solved. The effects of preventing OLED display screen from image-sticking and prolonging the service life of the OLED material can be achieved.

With respect to the device in the above aspects, the specific implementations of each module is described in details in the method aspects, which may not be described in details herein.

An exemplary aspect of the present disclosure provides a terminal which can achieve the method for preventing a display from image-sticking provided in the present disclosure. The terminal includes a processor and a memory storing instructions executed by the processor. Herein, the processor is configured to acquire a target image frame to be displayed, and determine image information of each display unit in the target image frame; determine, according to the image information of each display unit in the target image frame, the target display unit whose duration of the image information not changed reaches a preset duration threshold; and change images of the target display units in a consecutive preset number of image frames.

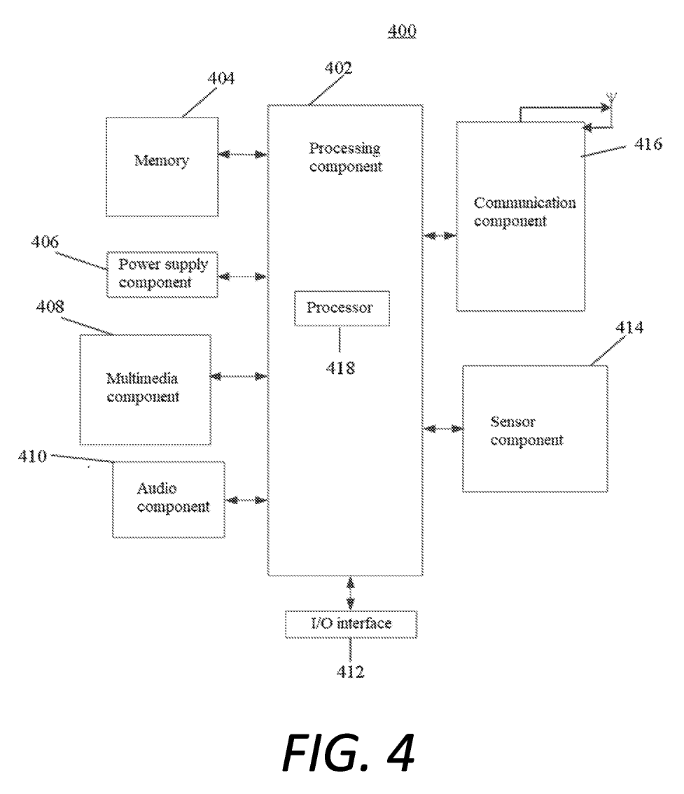

FIG. 4 is a block diagram of a terminal according to an exemplary aspect. Exemplarily, the terminal 400 may be a mobile phone, a computer, a digital broadcast terminal, a messaging device, a game console, a tablet device, a medical device, a fitness device, a personal digital assistant, and the like.

Referring to FIG. 4, the terminal 400 may include one or more of the following components: a processing component 402, a memory 404, a power supply component 406, a multimedia component 408, an audio component 410, an input/output (I/O) interface 412, a sensor component 414, and a communication component 416.

The processing component 402 generally can control the overall operation of the terminal 400, such as operations associated with display, phone call, data communication, camera operation, and recording operation. The processing component 402 may include one or more processors 418 for executing instructions, so as to complete all or part of the steps described above. In addition, the processing component 402 may include one or more modules to facilitate the interactions between the processing component 402 and other components. For example, the processing component 402 may include a multimedia module to facilitate interaction between the multimedia component 408 and the processing component 402.

The memory 404 can be configured to store various types of data to support the operation of the terminal 400. Examples of such data can include instructions of any application or method operated on the terminal 400, contact data, phonebook data, messages, pictures, videos, and the like. The memory storage 404 may be implemented by any type of volatile or nonvolatile memory device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, disk or CD.

The power supply component 406 may provide power to the various components of the terminal 400. The power supply component 406 may include a power management system, one or more power supplies, and other components associated with generation, management, and power distribution of the terminal 400.

The multimedia component 408 may include a screen providing an output interface between the terminal 400 and the user. In some aspects, the screen may include a liquid crystal display (LCD) and a touch panel (TP). If the screen includes a touch panel, the screen may be implemented as a touch screen to receive input signals from the user. The touch panel can include one or more touch sensors to sense touches, slides, and gestures on touch panels. The touch sensors may sense not only the boundary of the touch or slide actions, but also the duration and pressure associated with the touch or slide operation. In some aspects, the multimedia component 408 may include a front camera and/or a rear camera. When the terminal 400 is at an operating mode, such as a shooting mode or a video mode, the front camera and/or the rear camera can receive external multimedia data. Each front camera and rear camera can be a fixed optical lens system or have focal length and optical zoom capability.

The audio component 410 can be configured to output and/or input an audio signal. For example, the audio component 410 can include a microphone (MIC) that is configured to receive external audio signals when the terminal 400 is in an operating mode, such as a call mode, a recording mode, and a voice recognition mode. The received audio signals may be further stored in the memory 404 or transmitted via the communication component 416. In some aspects, the audio component 410 can also include a speaker for outputting the audio signals.

The I/O interface 412 can provide the interface between the processing component 402 and a peripheral interface module. The peripheral interface module may be a keyboard, a click wheel, buttons, or the like. The buttons may include, but are not limited to, a home button, a volume button, a start button, and a lock button.

The sensor component 414 may include one or more sensors for providing the terminal 400 with various aspects of status assessments. For example, the sensor component 414 may detect the on/off state of the terminal 400, the relative positioning of the components, such as the display and keypad of the terminal 400, and the sensor component 414 may also detect position changes of the terminal 400 or any component thereof, presence or absence of the contact between the user and the terminal 400, orientation or acceleration/deceleration of the terminal 400, or the temperature changes of the terminal 400. The sensor component 414 may include a proximity sensor configured to detect the presence of a nearby object without any physical contact. The sensor component 414 may also include a light sensor, such as a CMOS or CCD image sensor, for use in imaging applications. In some aspects, the sensor component 814 may also include acceleration sensors, gyro sensors, magnetic sensors, pressure sensors, or temperature sensors.

The communication component 416 can be configured to facilitate wired or wireless communication between the terminal 400 and other apparatuses. The terminal 400 may access a wireless network based on a communication standard, such as WiFi, 2G or 3G, or a combination thereof. In an exemplary aspect, the communication component 416 can receive broadcast signals or broadcast-related information from an external broadcast management system via broadcast channels. In an exemplary aspect, the communication component 416 can also include a near field communication (NFC) module to facilitate the short-range communication. For example, the NFC module may be implemented based on radio frequency identification (RFID) technology, infrared data association (IrDA) technology, ultra wideband (UWB) technology, Bluetooth (BT) technology and other technologies.

In an exemplary aspect, the terminal 400 may be implemented by one or more application specific integrated circuits (ASICs), digital signal processors (DSPs), digital signal processing devices (DSPDs), programmable logic devices (PLDs), field programmable gate array (FPGA), controllers, microcontrollers, microprocessors, or other electronic components for performing the method for preventing a display from image-sticking described in the above method aspects.

In an exemplary aspect, there is also provided a non-transitory computer-readable storage medium comprising instructions, such as the memory 404 including the instructions, the instructions may be executed by the processor 418 of the terminal 400 to complete the method for preventing a display from image-sticking described above. For example, the non-transitory computer readable storage medium may be a ROM, a random access memory (RAM), a CD-ROM, a magnetic tape, a floppy disk, an optical data storage device, etc.

A non-transitory computer-readable storage medium containing instructions that, when executed by a processor of the terminal, causes the terminal to implement the method for preventing the display from image-sticking. The method includes: acquiring a target image frame to be displayed, and determining image information of each display unit in a target image frame; determining, according to the image information of each display unit in the target image frame, the target display unit whose duration of the image information not changed reaches a preset duration threshold; and changing the image of the target display unit in a consecutive preset number of image frames.

Optionally, changing the images of the target display units in a consecutive preset number of image frames includes: changing the images of the target display units in a consecutive preset number of image frames subsequent to the target image frame.

Optionally, the display unit is a pixel point, and determining the image information of each display unit in the target image frame includes: determining a channel value of each color channel of each pixel point in the target image frame.

Optionally, the display unit is a display area composed of a plurality of pixel points, and determining the image information of each display unit in the target image frame includes: according to the channel value of each color channel of the pixel points in each display area, respectively calculating a feature code corresponding to each display area as the image information corresponding to each display area.

Optionally, changing the images of the target display units in a consecutive preset number of image frames includes: changing the images in the target display units in a consecutive preset number of image frames to be a preset image; or determining an interface content element corresponding to the target display unit, and adjusting the position of the interface content element in a consecutive preset number of image frames subsequent to the target image frame.

Optionally, determining, according to the image information of each display unit in the target image frame, the target display unit whose duration of the image information not changed reaches a preset duration threshold includes: determining, according to the image information of each display unit in the target image frame, the target display unit whose duration of the image information not changed reaches the preset duration threshold and the image information is not a preset image information, wherein the preset image information is the image information corresponding to pure black display content.

In the aspects of the present disclosure, the target display unit whose duration of the image information not changed reaches the preset duration threshold is determined according to the image information of each display unit in the target image frame in the image frames to be displayed. The images of the target display units in a consecutive preset number of image frames are changed. Since the duration of the image information of each display unit which is not changed does not reach the preset duration threshold, the problem of premature aging of the OLED material and the effect of the image-sticking due to the OLED display displays the same image for a long time can be solved. The effects of preventing OLED display screen from image-sticking and prolonging the service life of the OLED material can be achieved.

It should be understood that the singular form “one” (“a”, “an” and “the”) used in the context is intended to include the plural form, unless the context clearly supports the exception case. The “and/or” used in the text is intended to include any and all possible combinations of the one or more listed associated items.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other aspects of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for preventing a display from image-sticking, comprising:
acquiring a target image frame to be displayed;
determining image information of each display unit in the target image frame;
determining, based on the image information of each display unit in the target image frame, at least one target display unit having respective image information that has not changed for a duration that is equal to or greater than a preset duration threshold; and
changing an image of the at least one target display unit in a consecutive preset number of image frames.

2. The method according to claim 1, wherein the consecutive preset number of image frames are subsequent to the target image frame.

3. The method according to claim 1, wherein the display unit is a pixel point, and determining the image information of each display unit in the target image frame comprises:
determining a channel value of each color channel of each pixel point in the target image frame.

4. The method according to claim 1, wherein the display unit is a display area composed of a plurality of pixel points, and determining the image information of each display unit in the target image frame comprises:
calculating a feature code corresponding to each display area respectively as image information corresponding to each display area based on a channel value of each color channel of the pixel points in each display area.

5. The method according to claim 2, wherein the image of the at least one target display unit in the consecutive preset number of image frames is changed into a preset image.

6. The method according to claim 2, wherein changing the image of the at least one target display unit in the consecutive preset number of image frames comprises:
determining an interface content element corresponding to the at least one target display unit, and adjusting a position of the interface content element in the consecutive preset number of image frames subsequent to the target image frame.

7. The method according to claim 1, wherein the image information of the at least one target display unit does not correspond to pure black display content.

8. A terminal for preventing a display from image-sticking, comprising:
a processor; and
a memory for storing instructions executable by the processor,
wherein the processor is configured to:
acquire a target image frame to be displayed;
determine image information of each display unit in the target image frame;
determine, based on the image information of each display unit in the target image frame, at least one target display unit having respective image information that has not changed for a duration that is equal to or greater than a preset duration threshold; and
change an image of the at least one target display unit in a consecutive preset number of image frames.

9. The terminal according to claim 8, wherein the consecutive preset number of image frames are subsequent to the target image frame.

10. The terminal according to claim 8, wherein the display unit is a pixel point, and when determining the image information of each display unit in the target image frame, the processor is further configured to:
determine a channel value of each color channel of each pixel point in the target image frame.

11. The terminal according to claim 8, wherein the display unit is a display area composed of a plurality of pixel points, and when determining the image information of each display unit in the target image frame, the processor is further configured to:
calculate calculating a feature code corresponding to each display area respectively as image information corresponding to each display area based on a channel value of each color channel of the pixel points in each display area.

12. The terminal according to claim 9, wherein the image of the at least one target display unit in the consecutive preset number of image frames is changed into a preset image.

13. The terminal according to claim 9, wherein when changing the image of the at least one target display unit in the consecutive preset number of image frames, the processor is further configured to:
determine an interface content element corresponding to the at least one target display unit, and adjust a position of the interface content element in the consecutive preset number of image frames subsequent to the target image frame.

14. The terminal according to claim 8, wherein the image information of the at least one target display unit does not correspond to pure black display content.

15. A non-transitory computer-readable storage medium storing instructions that, when executed by one or more processors of a device, cause the device to:
acquire a target image frame to be displayed;
determine image information of each display unit in the target image frame;
determine, based on the image information of each display unit in the target image frame, at least one target display unit having respective image information that has not changed for a duration that is equal to or greater than a preset duration threshold; and
change an image of the at least one target display unit in a consecutive preset number of image frames.

16. The non-transitory computer-readable storage medium according to claim 15, wherein the consecutive preset number of image frames are subsequent to the target image frame.

17. The non-transitory computer-readable storage medium according to claim 15, wherein the display unit is a pixel point, and when determining the image information of each display unit in the target image frame, the instructions further cause the device to:
determine a channel value of each color channel of each pixel point in the target image frame.

18. The non-transitory computer-readable storage medium according to claim 15, wherein the display unit is a display area composed of a plurality of pixel points, and when determining the image information of each display unit in the target image frame, the instructions further cause the device to:
calculate a feature code corresponding to each display area respectively as image information corresponding to each display area based on a channel value of each color channel of the pixel points in each display area.

19. The non-transitory computer-readable storage medium according to claim 16, wherein when changing the image of the at least one target display unit in the consecutive preset number of image frames, the instructions further cause the device to:
determine an interface content element corresponding to the at least one target display unit, and adjust a position of the interface content element in the consecutive preset number of image frames subsequent to the target image frame.

20. The non-transitory computer-readable storage medium according to claim 15, wherein the image information of the at least one target display unit does not correspond to pure black display content.
